(19) United States
(12) Patent Application Publication
(10) Pub. No.: US 2008/0110311 A1
(43) Pub. Date: May 15, 2008

(54) Multiple-tool machine for combined cutting of slabs of hard material

(75) Inventor: Ampelio Stangherlin, Castello di Godego (TV) (IT)

Correspondence Address: Themis Intellectual Property Counsel, 7660 Fay Ave Ste H378, La Jolla, CA, 92037, US

(73) Assignee: SIMEC S.P.A., Castello di Godevo (TV) (IT)

(21) Appl. No.: 11/939,535

(22) Filed: Nov. 13, 2007

(30) Foreign Application Priority Data
Nov. 13, 2006 (IT) VI2006A000333

(51) Int. Cl. B26F 3/00; B23D 45/00

(52) U.S. Cl. 83/177; 83/471.2

(57) ABSTRACT

The present invention relates to processing of hard materials, and more particularly relates to a multiple-tool machine for the combined cutting of slabs of hard materials such as stone, marble, granite, concrete, wood, metal, glass and the like. One embodiment of the present invention includes a support surface for receiving a slab; a load-bearing frame with a longitudinal beam extending over the support surface; a first disk blade cutting tool mounted on a first slide and movable along a first guide connected to the beam; a first motion imparting device for moving the first slide; a second cutting tool with a nozzle for high-pressure waterjet cutting, which is mounted in sliding relationship to a second guide coupled to the beam; and a second motion imparting device, other than the first motion imparting device, for translating the second cutting tool independently of the first cutting tool.

### FIELD OF THE INVENTION

The present invention relates to the processing of hard materials. More particularly, the present invention relates to a multiple-tool machine for cutting slabs of hard materials, such as stone, marble, granite, concrete, wood, metal, glass and the like.

### BACKGROUND OF THE INVENTION

Various types of apparatus are known in the art for cutting slabs of hard material, such as stone, marble, granite, wood and metal materials, into a plurality of plates not necessarily of the same shape and size.

Generally, these apparatus include a work surface for receiving the slab to be cut, above which a rotary cutting tool, such as a disk, is translated.

Usually, a cutting disk machine first provides longitudinal cuts to form a plurality of strips. Then, the strips are separated, by hand or by sliding in special spacing grids, for later crosscutting.

This step is required especially when manufacturing tiles of different lengths to prevent the tool that cuts one strip from damaging the adjoining strip.

Therefore, the required sequence of steps includes rather long setup and dead times, which reduce the throughput of the apparatus considerably. Furthermore, any manual displacement of the strips may affect the safety of operators.

Cutting apparatus are also known, which use high pressure waterjet tools and in which the waterjet is suitably mixed with abrasive elements. Nevertheless, these apparatus are not of easy use, in terms of both operation and cost, causing the use of waterjets to be generally limited to the cutting of edges or small portions of the slab.

These apparatus may be placed downstream from the disk cutting apparatus, to receive the strips for crosscutting.

Here again, the overall layout times are rather long, and two different cutting stations have to be provided, thereby affecting the cost effectiveness of the whole process.

In an attempt to obviate the above mentioned drawbacks, solutions have been proposed to manage the entire slab cutting process automatically in one cutting station.

WO2006/043294 discloses a multiple-tool cutting machine in which a tool-holder slide is moved along a longitudinal beam overlying the slab to be cut. A disk cutting tool and a waterjet cutting nozzle are both mounted to the slide, and operate alternately or according to a specific sequence. More particularly, once the disk has carried out the longitudinal cutting step, the nozzle is employed for crosscutting of the slab only at the edges of the longitudinal strips.

By this arrangement, the higher accuracy of the nozzle as compared with the use of the disk can be employed, while at the same time damages to the strips adjacent the strip being cut are prevented.

While this solution eliminates the steps of manually preparing the strips to be cross-cut, simultaneous and independent control of the two slide-mounted tools are not enabled, therefore, the disk and the nozzle cannot be used at the same time.

A combined cutting apparatus that includes both a blade cutting tool and a waterjet cutting tool is also disclosed in US2006/0135041, but here the two tools are separate and movable independently along the beam.

One drawback of this solution is that the two tools are moved on common guide and cannot be used at the same time or simultaneous use thereof is greatly restricted, resulting in a reduced throughput of the entire apparatus. Furthermore, the waterjet tool is only movable along three axes wherefore, after blade cutting, the beam has to be repositioned for alignment of the tool nozzle with the blade cut, with a disadvantageous increase of dead times.

### SUMMARY OF THE INVENTION

It is an object of the present invention is to overcome the drawbacks in the prior art by providing a machine for combined cutting of slabs of hard material that is highly efficient and relatively cost effective.

It is another object of the present invention to provide a cutting apparatus that has two independently controllable cutting tools.

It is a further object of the present invention is to provide an apparatus for combined cutting of slabs, in which the tools can operate either at the same time or sequentially.

It is yet another object of the present invention is to provide an apparatus that ensures a high throughput as compared with the other available cutting apparatus.

These and other objects, as better explained hereafter, are achieved by a multiple-tool machine for combined cutting of slabs of hard material that includes a substantially horizontal, fixed or adjustable support surface for receiving a slab to be cut, a load-bearing frame with a pair of vertical posts and a substantially horizontal longitudinal beam, a first disk blade cutting tool mounted to a first slide moving along a first guide connected to the beam, a first motion providing device for moving the first slide along the first guide, and a second high pressure waterjet cutting tool to complete the cuts at the end areas and/or for finishing purposes.

According to an aspect of the invention, the second cutting tool has a nozzle mounted in sliding relationship to a second guide associated to the beam, there being provided second motion imparting device, other than the first motion imparting device to promote translation of the second cutting tool independently of the first cutting tool.

Due to this aspect of the invention, the first and second tools can carry out cutting operations, possibly at the same time on different areas of the slab, thereby enabling a very quick completion of the slab cutting process.

Advantageously, the second tool may be mounted to a second slide moving along second guide.

Preferably, the second guide includes a substantially horizontal rail, formed of a single piece with the beam.

One or more microprocessor control units may be provided to control the first, second and third motion imparting devices, the first and second adjustment devices and the drive.

By virtue of the above described configuration, the apparatus of the present invention provides independent control of the tools that can be driven and operated in either independent or coordinated mode.

Thus, the slab may be cut into a plurality of shapes of any size and geometry, not necessarily the same, with no need for manual handling of the semi-finished workpieces, while ensuring high levels of safety and throughput.

### BRIEF DESCRIPTION OF THE DRAWINGS

Additional features and aspects of the invention will be more apparent upon a reading of the detailed description of non-exclusive embodiments of a multiple-tool machine for combined cutting of slabs according to the invention, which is described as a non-limiting example with the support of the enclosed drawings, in which:

FIG. 1 is a perspective view of a machine according to the an embodiment of the invention;

FIG. 2 is a front view of the machine of FIG. 1;

FIG. 3 is a top view of the machine of FIG. 1;

FIG. 4 illustrates a slab processing lay-out using an apparatus constructed according to the principles of the present invention;

FIG. 5 is a front view of a detail of a disk blade during the cutting step;

FIG. 6 is a front sectional view of a detail of a slab cut by a disk blade.

### DETAILED DESCRIPTION OF EMBODIMENTS OF THE INVENTION

Referring to the figures, a machine according to the invention, generally designated by numeral 1, may be used for cutting slabs of hard material, such as marble, granite, metal, wood or the like, into a plurality of shapes of different sizes and geometries.

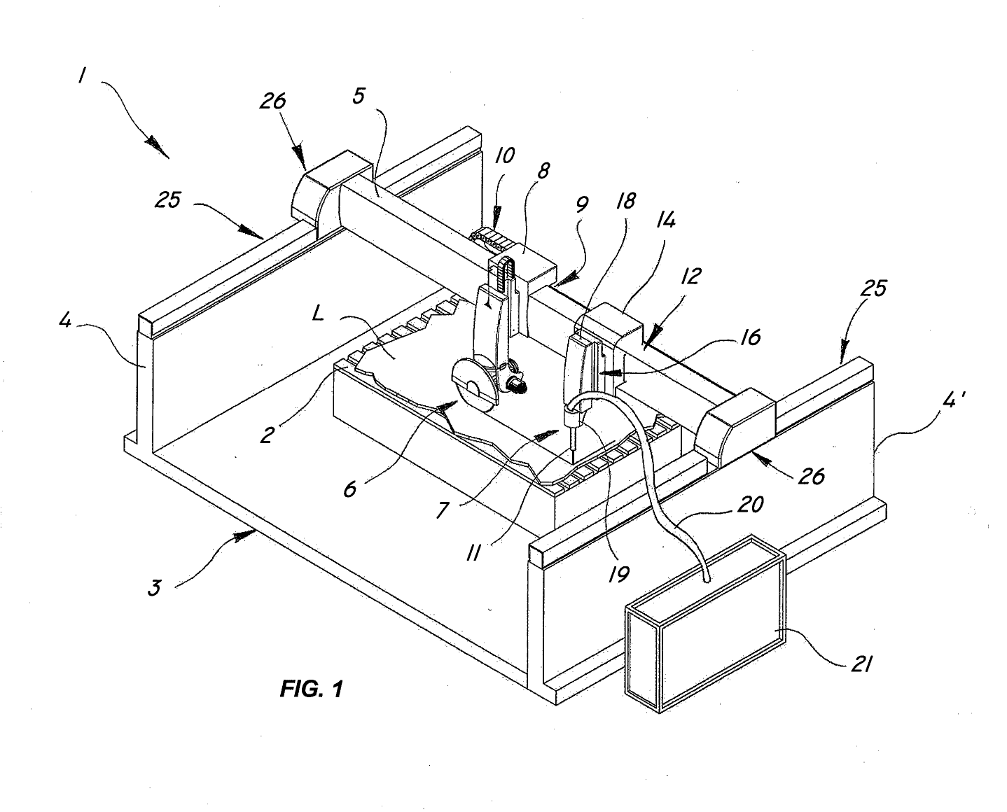

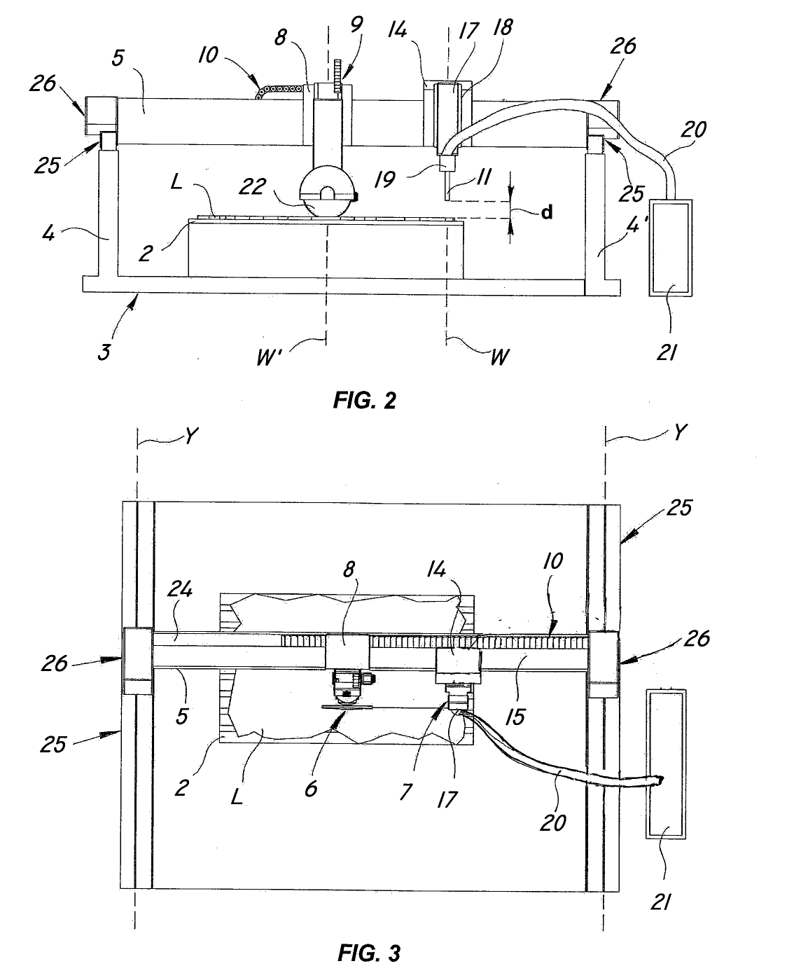

As shown more particularly in FIG. 1, a machine for the combined cutting of slabs comprises a substantially horizontal, fixed or adjustable support surface 2 for receiving a slab L to be cut; a load-bearing frame 3 with a pair of vertical posts 4, 4′; a substantially horizontal longitudinal beam 5, overlying the support surface 2; a first disk blade cutting tool 6 for making cuts of predetermined lengths on the slab L; and a second cutting tool 7 with a nozzle 11 for high-pressure waterjet cutting, which is designed to complete the cuts at the end areas and/or for finishing purposes.

The first tool 6 is mounted to a first slide 8 moving along a first guide 9 associated to beam 5, a first motion imparting device 10 being further provided for moving first slide 8 along first guide 9.

A second cutting tool 7 is slideably mounted to a second device 12 associated to beam 5, there being provided a second motion imparting device 13, other than the first motion imparting device 10 to promote translation of second cutting tool 7 independently of first cutting tool 6.

Thus, first and second tools 6, 7 may carry out respective cutting operations, either simultaneously or sequentially, even on different areas of slab L.

Particularly, second tool 7 may be mounted to a second slide 14, moving along the beam 5 in second guide 12.

According to a preferred, non exclusive embodiment of the invention, these devices may be of the recirculating ball type with a substantially horizontal rail 15 formed of one piece with beam 5 and a motion actuating carriage, not shown, associated to second slide 14 and sliding in horizontal rail 15 to cause longitudinal translation of second tool 7.

Advantageously, nozzle 11 may be mounted to second slide 14 with the interposition of first substantially horizontal adjustment device 16, in turn comprising a third slide 17, moving along a substantially vertical guide rail 18 associated to second slide 14.

Third slide 17 may be associated to a drive, not shown, for adjusting the distance d of nozzle 11 from support surface 2 and slab L lying thereon.

In accordance with a preferred configuration, the drive may comprise a recirculating ball screw driven by a motor, not shown due to its inherent presence, for a precise positioning of nozzle 11 along a first vertical axis W.

Also, nozzle 11 may be mounted to a spindle 19 that can be rigidly coupled to third slide 17 or mounted thereon in a tilting relationship with a first transverse axis Y. For instance, spindle 19 may be mounted to third slide 17 via a joint, not shown, for undercutting functions. Otherwise, spindle 19 may be mounted to third slide 17 via second adjustment device operating along a direction parallel to the first transverse axis Y.

The second adjustment device may include a transverse guide, also not shown, for nozzle 11 to slide in either direction, integrally with spindle 19, parallel to first transverse axis Y.

Thus, limited transverse movements in either direction may be imparted to nozzle 11, relative to beam 5, for an advantageous alignment thereof with a specific cut made by first tool 6, thereby allowing second tool 7 to operate at the same time as first tool 6.

Second tool 7 may be supplied with working fluid, generally pressurized water, possibly mixed with abrasive particles, via a supply pipe 20 connected to a tank 21 in a known manner.

First tool 6 may be also constructed according to a prior art configuration, with disk blade 22 linked to its slide 8 by means of an appropriate connecting joint device 23 that will allow rotation about a second vertical axis W′, for cross- or oblique cutting of slab L.

First guide 9 may include an additional horizontal rail or guide 24 other than rail 15 of second slide 14.

Beam 5 may be mounted in sliding relationship to posts 4, 4′, with the interposition of third guide 25, and driven by third motion imparting device 26 for translation along a second transverse axis Y′ above the slab to be cut.

Thus, tools 6, 7 may be moved all along the transverse extension y of slab L, for the cutting process to be completed in an easy and quick manner, without requiring any manual or automatic displacement of slab L or support surface 2 on which it is disposed.

Therefore, it will be appreciated that second tool 7 can move along four axes, i.e. along first transverse axis Y, first vertical axis W, second transverse axis Y′, as beam 5 is translated, and finally along additional axis X defined by second guide device 12, which substantially coincides, in the illustrated example, with the main direction of extension of beam 5.

The motion of beam 5, slides 8, 14, and the two tools 6, 7 connected thereto, may be managed through one or more microprocessor control units, not shown because known in the art, that can control the first, second and third motion imparting devices 10, 13, 26, the first and second adjustment devices and the drives in either independent or coordinated mode.

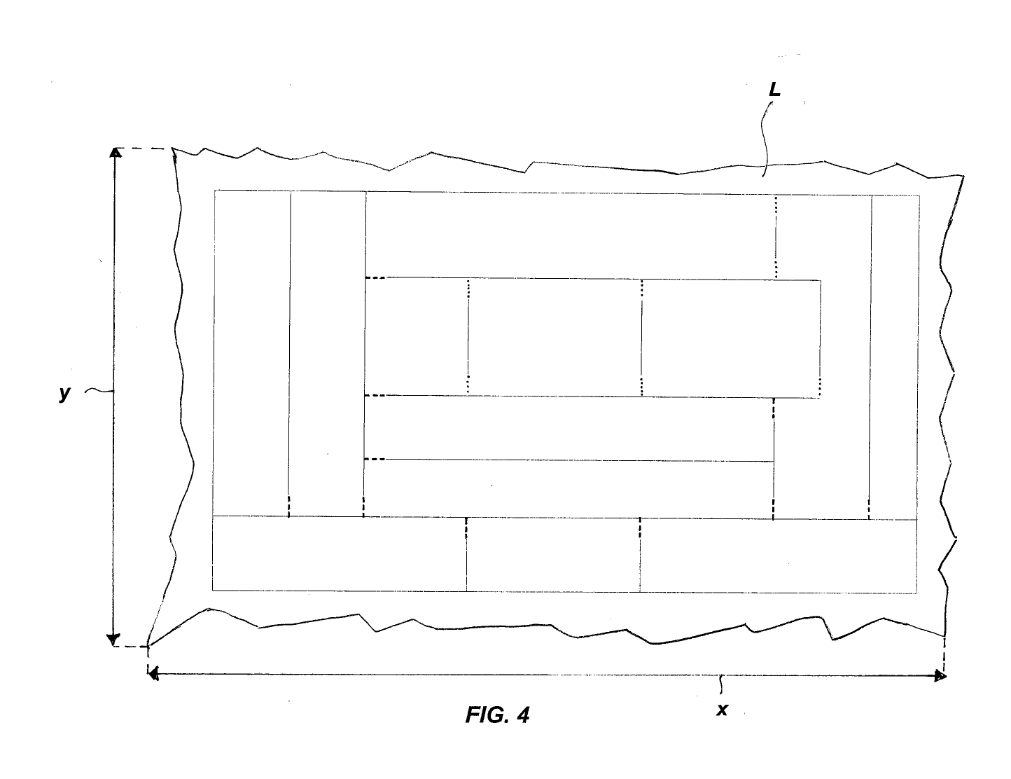

FIG. 4 shows an exemplary processing scheme for a slab L using an apparatus 1 as described above. More particularly, solid lines designate cuts made by first tool 6 operating alone, dotted lines designate cuts made by second tool 7 operating alone and finally dashed lines designate cuts made by second tool 7 operating at the same time as first tool 6.

A possible mode of use of the apparatus of the invention is described hereinafter.

A slab L having a constant 20 mm thickness s throughout its length and a 3500 mm maximum longitudinal dimension x and a 2000 mm maximum transversal dimension y is assumed to be cut. The cutting process will be optimized according to the lay-out of FIG. 4.

Three tables are given hereinbelow, indicating both the longitudinal and cross-cuts made by the two tools 6, 7. More particularly, TABLE A indicates the cuts made by first tool 6 operating alone, TABLE B indicates the cuts made by second tool 7 operating alone, and finally TABLE C indicates the cuts made by the two tools 6, 7 in simultaneous operation.

TABLE A

| x_{L} - longitudinal cut length (in mm) | y_{L} - cross-cut length (in mm) |
|---|---|
| 3260 | 1870 |
| 2050 | 1400 |
| 2050 | 550 |
| 1900 | 280 |
| 3260 | 330 |
| 3260 | 430 |
| | 350 |
| | 350 |
| | 430 |
| | 1400 |
| | 1400 |
| | 1870 |

Partial total length

| | |
|---|---|
| 15780 | 10660 |

TABLE B

| xᵤ - longitudinal cut length (in mm) | yᵤ - crosscut length (in mm) |
|---|---|
| | 60 |
| | 60 |
| | 60 |
| | 60 |
| | 60 |
| | 60 |
| | 60 |

Partial total length

| | |
|---|---|
| 0 | 420 |

TABLE C

| x_{c} - longitudinal cut length (in mm) | y_{c} - crosscut length (in mm) |
|---|---|
| 60 | 60 |
| 60 | 60 |
| 60 | 60 |
| | 60 |
| | 60 |
| | 60 |
| | 60 |

Partial total length

| | |
|---|---|
| 180 | 420 |

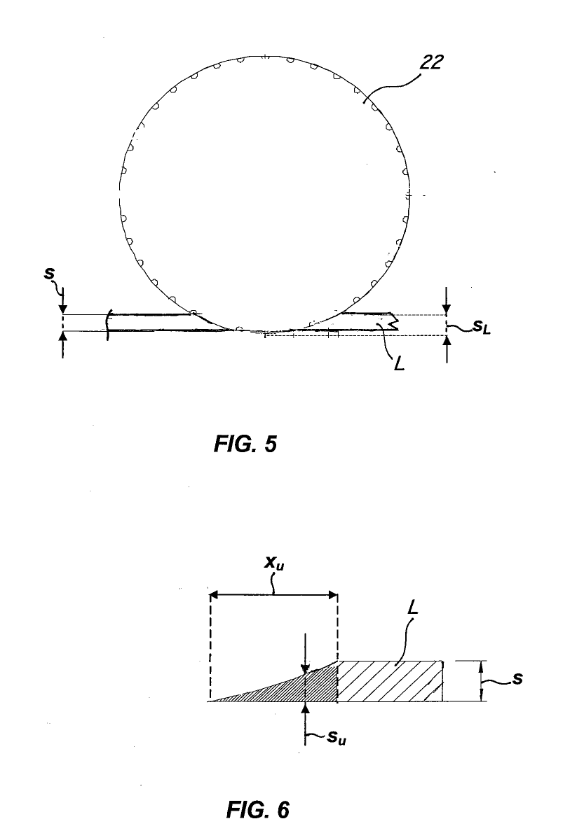

As particularly shown by the enlarged detail of FIG. 5, disk blade 22 penetrates to a 30 mm cutting depth S_{L}, i.e. larger than the thickness s of the slab L, to ensure a sharper cut and to avoid a chipping of the edges of the tiles resulting from slab L.

Therefore, second tool 7 completes the cut trough a length xᵤ, in this case about 60 mm, and a depth sᵤ not always equal to the cutting depth s_{L} of the blade 22, as shown in FIG. 6.

The translation speed vᵤ of nozzle 11 also changes as a function of the change of the cutting depth sᵤ. Therefore, assuming a 2.060 m/minute translation speed vᵤ₁ for 10 mm cutting depths sᵤ and a 0.93 m/minute speed vᵤ₂ for 20 mm cutting depths sᵤ, then a 1.4 m/minute average speed vᵤₘ may be determined. It is further assumed that the first tool 6 translates at a 3.5 m/minute speed V_{L} for both cross- and longitudinal cutting.

For simplicity, as a further approximation, the positioning times for the apparatus are assumed, in the worst scenario, to be zero. Nevertheless, during positioning of first tool 6, slab L may be cut by second tool 7, thereby affording additional advantages in terms of dead time reduction and increase of the overall throughput of machine 1.

Based upon the above mentioned assumptions, first tool 6 can operate alone for a time t_{L} corresponding to:

(x_{L}+y_{L})/v_{L}=(15780+10660)/3.5=7.55 minutes

On the simplified assumptions regarding the average speed vᵤₘ of second tool 7, the latter vᵤₘ operate alone for a time tᵤ given by:

(xᵤ+yᵤ)/vᵤₘ=(0+420)/1.4=0.3 minutes

The time t_{c} during which the tools operate at the same time will be:

(x_{c}+y^{c})/vᵤₘ=(180+420)/1.4=0.43 minutes

The latter value reflects time savings as compared to a process, in which waterjet cutting nozzle 11 cannot be controlled independently of disk blade tool 6.

Considering the above approximations, this value will provide a minimum time saving value and will be 5.5% of the overall operating time.

The above disclosure clearly shows that the invention fulfills the intended objects and particularly meets the requirement of providing an apparatus for combined cutting of slabs of hard material, in which two cutting tools, including one high pressure waterjet tool, may be used at the same time even on different areas of the slab.

Thanks to the particular configuration of the motion imparting device and of the guide for each tool, tools 6, 7 will have higher degrees of freedom than in prior art apparatus, thereby affording relatively quick cutting processes with markedly reduced dead times.

The machine of the present invention is susceptible of a number of changes and variants, within the scope of the invention disclosed in the appended claims. All the details thereof may be replaced by other technically equivalent parts, and the materials may vary depending on different needs, without departing from the scope of the invention.

While the machine of the present invention has been described with particular reference to the accompanying figures, the numerals referred to in the disclosure and claims are only used for the sake of a better intelligibility of the invention and shall not be intended to limit the claimed scope in any manner.

What is claimed is:

1. A multiple-tool machine for combined cutting of slabs of hard material, the machine comprising:
a fixed or adjustable support surface (2) for receiving a slab (L) to be cut;
a load-bearing frame (3) for receiving the support surface, the load-bearing frame comprising a plurality of vertical posts (4, 4′) disposed in a direction essentially perpendicular the support surface and coupled to a longitudinal beam (5) overlying the support surface (2);
at least one first cutting tool (6) having a disk blade (22) for making cuts of predetermined lengths on the slab (L), the first tool (6) being mounted on a first slide (8) movable along a first guide (9) connected to the beam (5);
a first motion imparting device (10) for moving the first slide (8) along the first guide (9); and
at least one second cutting tool (7) with a nozzle (11) for high-pressure waterjet cutting, the at least one second cutting tool completing the cuts at the end areas and/or providing a finishing;
wherein the at least one second cutting tool (7) is slideably mounted to a second guide (12) associated to the beam (5), and
wherein a second motion imparting device (13) other than the first motion imparting device (10) promotes translation of the second cutting tool (7) independently of the first cutting tool (6), thereby enabling the first (6) and the second (7) cutting tools to effectuate respective simultaneous cutting operations on different areas of the slab (L).

2. The machine as claimed in claim 1, wherein the second cutting tool (7) is mounted on a second slide (14) slidable on the second guide (12).

3. The machine as claimed in claim 2, wherein the second guide (12) comprises a rail coupled to the beam (5).

4. The machine as claimed in claim 3, wherein the nozzle (11) is connected to the second slide (14) by interposing a first adjustment device (16) between the nozzle (11) and the second slide (14).

5. The machine as claimed in claim 4, wherein the first adjustment device (16) comprises a third slide (17) mounted slidably on a guide rail (18) connected to the second slide (14).

6. The machine as claimed in claim 5, wherein the nozzle (11) is mounted to a spindle (19) connected to the third slide (17).

7. The machine as claimed in claim 6, wherein the third slide has a second adjustment device for the spindle (19), the third slide orienting the nozzle (11) relative to a first transverse axis (Y) substantially parallel to the support surface (2).

8. The machine as claimed in claim 6, wherein the third slide has a second adjustment device for the spindle (19), the second adjustment device being configured to operate along a direction substantially parallel to the first transverse axis (Y) in opposite directions so to displace the nozzle (11) parallel to the first transverse axis (Y).

9. The machine as claimed in claim 5, wherein the third slide (17) is connected to a drive for adjusting the distance (d) of the nozzle (11) from the support surface (2).

10. The machine as claimed in claim 9, wherein the drive comprises a recirculating ball screw for a precision positioning of the nozzle (11) along a first axis (W) along a direction substantially perpendicular to the support surface (2).

11. The machine as claimed in claim 10, wherein the beam (5) is slidable along a second transverse axis (Y′) substantially parallel to the support surface (2) on a third guide (25) connected to at least one of the posts (4, 4′), and wherein a third motion imparting device (26) promotes translation of the beam (5) along the third guide (25).

12. The machine as claimed in claim 11, further comprising at least one microprocessor control unit for controlling the first, second and third motion imparting devices (10, 13, 26), the adjustment device (16), and the drive in independent and coordinated mode.
